(19) United States
(12) Patent Application Publication
(10) Pub. No.: US 2008/0280128 A1
(43) Pub. Date: Nov. 13, 2008

(54) Water-Absorbing Polymer Structure Surface-Treated with Polycations

(76) Inventors: Franck Furno, Dusseldorf (DE); Mirko Walden, Herten (DE); Jorg Issberner, Willich-neersen (DE); Harald Schmidt, Tonisvorst (DE)

Correspondence Address: SMITH MOORE LEATHERWOOD LLP, P.O. BOX 21927, GREENSBORO, NC, 27420, US

(21) Appl. No.: 11/912,241

(22) PCT Filed: Apr. 21, 2006
(86) PCT No.: PCT/EP2006/003695

§ 371 Date: Jun. 12, 2008

(30) Foreign Application Priority Data
Apr. 22, 2005 (DE) 10 2005 018 922.9

(51) Int. Cl. B32B 27/16; C08G 73/06

(52) U.S. Cl. 428/327; 428/407; 528/423

(57) ABSTRACT

The present invention relates to water-absorbing polymer structures, whose surface has been brought into contact with a compound comprising a polycation and at least one anion. The invention further relates to a process for treating the surface of water-absorbing polymer structures, the surface-treated water-absorbing polymer structures obtainable by this process, a composite comprising a surface-treated, water-absorbing polymer structure as well as a substrate, a process for production of a composite, the composite obtainable by this process, chemical products such as foams, formed bodies, and fibers comprising surface-treated water-absorbing polymer structures or a composite, the use of surface-treated, water-absorbing polymer structures or of a composite in chemical products as well as the use of compounds comprising a polycation with a given structure for the treatment of the surface of water-absorbing polymer structures.

This application is a national stage application under 35 U.S.C. 371 of international application No. PCT/EP2006/003695 filed 21 Apr. 2006, and claims priority to German Application No. DE 10 2005 018 922.9 filed 22 Apr. 2005, the disclosure of which is expressly incorporated herein by reference.

### BACKGROUND

The present invention relates to a water-absorbing polymer structure, a process for treatment of the surface of water-absorbing polymer structures, the surface-treated, water-absorbing polymer structures obtainable by this process, a composite comprising a water-absorbing polymer structure as well as a substrate, a process for production of a composite, the composite obtainable by this process, chemical products such as foams, formed bodies and fibers comprising water-absorbing polymer structures or a composite, the use of water-absorbing polymer structures or of a composite in chemical products as well as the use of compounds comprising a polycation with a given structure for treatment of the surface of water-absorbing polymer structures.

Superabsorbers are water-insoluble, cross-linked polymers, which are able to absorb and retain under a given pressure large quantities of aqueous liquids, in particular body fluids, preferably urine or blood, by swelling and forming hydrogels. Because of these characteristic properties, these polymers principally find applications through incorporation into sanitary articles, such as, for example, baby diapers, incontinence products, or feminine hygiene products.

The production of the superabsorbers generally occurs by radical polymerization of acid groups-carrying monomers in the presence of crosslinkers. In this way, polymers with different absorbent properties can be produced by the choice of the monomer composition, the crosslinkers and the polymerization conditions and the processing conditions for the hydrogel obtained after the polymerization. The production of graft polymers, for example by use of chemically modified starches, celluloses, and polyvinyl alcohols according to DE-OS 26 12 846 and the post-treatment of the hydrogels or of the powdery polymer particles obtained after drying of the hydrogels by post-crosslinking of the surfaces of the polymer particles, for example, according to DE 40 20 780 C1, offer further possibilities. Through the post-crosslinking of the surface of the water-absorbing polymer particles, in particular, the absorption capacity of the polymer particles under the action of pressure is increased.

EP 0 248 963 A2 suggests coating the water-absorbing polymer particles with polyquaternary amines, in order to improve the absorption capacity and the retention of water. The disadvantage of the water-absorbing polymer particles described in EP 0 248 973 A2 is, however, that although these do indeed have an improved absorption capacity and an improved retention as a result of the coating with the quaternary amines used therein, absorbent structures which comprise these polymers in high concentrations are, however, characterized by an unsatisfactory absorption behavior. This unsatisfactory absorption behavior displays itself in particular in the so-called “gel blocking” effect. By this gel blocking effect is understood the observation that in absorbent structures, because of the restricted permeability of the absorbent structure, the diffusion of liquids into the structure is less than the speed with which the liquid enters into the absorbent structure, so that, if, for example, the absorbent structure is a diaper, leakage can occur.

The present invention had, therefore, the object of overcoming the disadvantages arising from the state of the art.

In particular, the present invention had the object of providing superabsorbers, as well as absorbent structures comprising these superabsorbers in large amounts, which, in addition to excellent absorption and retention properties, are also characterized by particularly advantageous permeability properties.

A further object of the present invention was to provide a process with which superabsorbers as well as a composite comprising these superabsorbers with the above advantages can be prepared.

### SUMMARY

A contribution to the solution of the above-mentioned objects is provided by a water-absorbing polymer structure, whose surface has been brought into contact with a compound comprising a polycation and at least one anion and which preferably has an absorption under a pressure of 50 g/cm² determined according to ERT 442.2-02 (ERT=Edana Recommended Test Method) of at least about 16 g/g, or at least about 18 g/g, or at least about 20 g/g, whereby an absorption under a pressure of 50 g/cm² of about 100 g/g, or of about 50 g/g, or of about 40 g/g is not exceeded (in the case of particles, respectively determined for the whole particle fraction).

A contribution to the solution of the above-mentioned objects is also provided by a water-absorbing polymer structure, whose surface may be brought into contact with a compound comprising a polycation and at least one anion, wherein the compound comprising a polycation and at least one anion has a weight average of the molecular weight of more than about 3,000 g/mol, or more than about 4,000 g/mol, or more than about 5,000 g/mol, or more than about 7,000 g/mol, or more than about 10,000 g/mol, whereby a weight average of the molecular weight of about 100,000,000 g/mol, or of about 10,000,000 g/mol is not exceeded.

### DETAILED DESCRIPTION

In a preferred embodiment of the water-absorbing polymer structures according to the invention, these are surface post-crosslinked. Surface cross-linked polymer structures are characterized in that they comprise an inner region and an outer region surrounding the inner region, whereby the outer region has a higher degree of crosslinking than the inner region.

Polymer structures preferred according to the invention are fibers, foams, or particles, whereby fibers and particles are preferred and particles particularly preferred.

Polymer fibers according to the invention are so dimensioned that they can be incorporated in or as yarns for textiles and also directly in textiles. It is preferred according to the invention that the polymer fibers have a length from about 1 to about 500 mm, or from about 2 to about 500 mm, or from about 5 to about 100 mm, and a diameter from about 1 to about 200 Denier, or from about 3 to about 100 Denier, or from about 5 to about 60 Denier.

Polymer particles according to the invention may be dimensioned so that they have an average particle size according to ERT 420.2-02 from about 10 to about 3,000 μm, or from about 20 to about 2,000 μm, or from about 150 to about 850 μm, or from about 150 to about 600 μm. In an embodiment of the invention, the portion of polymer particles with a particle size within a range from about 300 to about 600 μm is at least about 30 wt %, or at least about 40 wt %, or at least about 50 wt %, or at least about 75 wt %, based upon the total weight of the post-crosslinked, water-absorbing polymer particles. According to another embodiment of the water-absorbing polymer structures according to the invention, the portion of polymer particles with a particle size within a range from about 150 to about 850 μm is at least about 50 wt %, or at least about 75 wt %, or at least about 90 wt %, or at least about 95 wt %, based upon the total weight of the post-crosslinked water-absorbing polymer particles.

In a preferred embodiment of the water-absorbing polymer structures according to the invention, these are based upon:
(α1) from about 20 to about 99.999 wt %, or from about 55 to about 98.99 wt %, or from about 70 to about 98.79 wt % of polymerized, ethylenically unsaturated, acid groups-carrying monomers or salts thereof or polymerized, ethylenically unsaturated monomers comprising a protonated or quatemated nitrogen, or mixtures thereof, whereby mixtures comprising at least ethylenically unsaturated, acid groups-comprising monomers, such as acrylic acid,
(α2) from 0 to about 80 wt %, or from 0 to about 44.99 wt %, or from 0.1 to about 44.89 wt % of polymerized, monoethylenically unsaturated monomers that may be co-polymerizable with (α1)
(α3) from 0.001 to about 5 wt %, or from 0.01 to about 3 wt %, or from 0.01 to about 2.5 wt % of one or more crosslinkers,
(α4) from 0.001 to about 10 wt %, or from 0.01 to about 7.5 wt %, or from about 0.5 to about 5 wt % of the compound comprising at least one anion and a polycation,
(α5) from 0 to about 30 wt %, or from 0 to about 5 wt %, or from 0.1 to about 5 wt % of a water-soluble polymer,
(α6) from 0 to about 20 wt %, or from about 2.5 to about 15 wt %, or from about 5 to about 10 wt % water, and
(α7) from 0 to about 20 wt %, or from 0 to about 10 wt %, or from 0.1 to about 8 wt % of one or more additives, whereby the sum of the weight amounts (α1) to (α7) is 100 wt %.

The monoethylenically unsaturated, acid groups-comprising monomers (α1) may be partially or fully neutralized. The monoethylenically unsaturated, acid groups-comprising monomers may be neutralized to at least about 25 mol %, or to at least about 50 mol %, or from about 50 to about 80 mol %. In this context, reference is made to DE 195 29 348 A1. The neutralization may also occur partially or fully after polymerization. Furthermore, the neutralization may be carried out with alkali metal hydroxides, alkaline earth metal hydroxides, ammonia, as well as carbonates and bicarbonates. In addition, any further base which forms a water-soluble salt with the acid is conceivable. A mixed neutralization with different bases is also a possibility. Neutralization with ammonia and alkali metal hydroxides, particularly sodium hydroxide, may be used.

The free acid groups may predominate in a polymer, so that this polymer has a pH value lying in the acidic region. Such an acidic water-absorbing polymer may be at least partially neutralized by a polymer with free basic groups, preferably amine groups, which is basic compared to the acidic polymer. These polymers are described in the literature as “Mixed-Bed Ion-Exchange Absorbent Polymers” (MBIEA-Polymers) and are disclosed in WO 99/34843 A1, among other patent publications. MBIEA Polymers generally have a composition that may comprise on the one hand basic polymers, which are able to exchange anions, and on the other hand, a polymer which is acidic in comparison to the basic polymer, which is capable of exchanging cations. The basic polymer comprises basic groups and is typically obtained by polymerization of monomers which carry basic groups, or groups which can be converted into basic groups. These monomers may be those which comprise primary, secondary, or tertiary amines, or corresponding phosphines, or at least two of the above functional groups. In particular ethyleneamine, allylamine, diallylamine, 4-aminobutene, alkyloxycycline, vinylformamide, 5-aminopentene, carbodiimide, formaldacine, melamine, and the like, as well as their secondary or tertiary amine derivatives, belong to this group of monomers.

Ethylenically unsaturated, acid groups-comprising monomers (α1) may include compounds that are mentioned as ethylenically unsaturated acid groups-comprising monomers (α1) in WO 2004/037903 A2, which portion directed to Ethylenically unsaturated, acid groups-comprising monomers is hereby incorporated as reference and thus forms part of the disclosure. Furthermore, ethylenically unsaturated, acid groups-comprising monomers (α1) may include acrylic acid and methacrylic acid.

According to an embodiment of the process according to the invention, water-absorbing polymer structures may be used, in which the monoethylenically unsaturated monomers (α2) which are co-polymerizable with (α1) are acrylamides, methacrylamides or vinylamides.

Examples of (meth)acrylamides include, besides acrylamide and methacrylamide, alkyl-substituted (meth)acrylamides or aminoalkyl-substituted derivatives of (meth)acrylamide, such as N-methylol(meth)acrylamide, N,N-dimethylamino(meth)acrylamide, dimethyl(meth)acrylamide or diethyl(meth)acrylamide. Possible vinyl amides are, for example, N-vinylamides, N-vinylformamides, N-vinylacetamides, N-vinyl-N-methylacetamide, N-vinyl-N-methylformamides, and vinylpyrrolidone.

According to another embodiment of the process according to the invention, water-absorbing polymer structures may be used, in which the monoethylenically unsaturated monomers (α2) that are co-polymerizable with (α1) are water-soluble monomers. In this context, alkoxypolyalkalineoxide(meth)acrylates such as methoxypolyethylene glycol (meth)acrylates are examples.

Other monoethylenically unsaturated monomers (α2) which are co-polymerizable with (α1) are water-dispersible monomers including acrylic acid esters and methacrylic acid esters, such as methyl(meth)acrylate, ethyl(meth)acrylate, propyl(meth)acrylate, or butyl (meth)acrylate.

The monoethylenically unsaturated monomers (α2) that may be co-polymerizable with (α1) further comprise methylpolyethylene glycol allylethers, vinylacetate, styrene, and isobutylene.

Crosslinker (α3) may include compounds disclosed in WO 2004/037903 A2. Crosslinker (α3) may include water-soluble crosslinkers, and further include N,N′-methylenebisacrylamide, polyethylene glycol di(meth)acrylates, triallylmethylammonium chloride, tetraallylammonium chloride, as well as allylnonaethylene glycol acrylate prepared with 9 mol ethylene oxide per mol of acrylic acid.

Compound (α4) comprising at least one anion and a polycation may include compounds, in which the polycation has the structure I

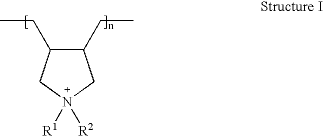

in which
R¹ and R² may be the same or different, and represent a hydrocarbon residue from one to about 10 carbon atoms, or from 1 to about 7 carbon atoms, or from 1 to 4 carbon atoms, or from 1 to 2 carbon atoms, or a methyl group, and n has a value of at least about 25, or at least about 31, or at least about 100, or at least about 1,000, or at least about 2,000, or at least about 2,500, or at least about 3,000, or at least about 5,000.

Polycations of structure I may include polydiallyldimethylamines. Anions may include the chloride ion, the bromide ion, the iodide ion, the sulfide ion, the sulfate ion, the sulfite ion, the nitrate ion, the nitrite ion, the acetate ion, the lactate ion, the carbonate ion, the hydrogencarbonate ion, the phosphate ion, the phosphite ion, and the hydroxide ion. In addition to these mono- or divalent anions, the compound may also comprise polyvalent anions. A compound comprising at least one anion and a polycation is a polymer of diallyldimethylammonium chloride with a value of n of at least about 25, or at least about 31, or at least about 100, or at least about 1,000, or least about 2,500, or at least about 5,000.

Water-soluble polymers (α5) may include polymers such as partially or fully saponified polyvinylalcohol, polyvinylpyrrolidone, starches, or starch derivatives, polyglycols, or polyacrylic acids may be comprised, or polymerized into the polymer structures. The molecular weight of these polymers may not be critical, as long as the polymers are water-soluble. Water-soluble polymers may further include starches, starch derivatives, or polyvinyl alcohol. The water-soluble polymers, such as polyvinylalcohol, may also serve as graft basis for the monomers to be polymerized.

Additive (α6) may be a suspending agent, odor binder, surfactant, or anti-oxidant, as well as those additives which have been used in the production of the polymer structures (initiators etc.) and included in the polymer structures.

In an embodiment of the polymer structures according to the invention, these are based to at least about 50 wt %, or to at least about 70 wt %, or to at least about 90 wt % on carboxylate groups-carrying monomers. Furthermore, component (α1) may include to at least about 50 wt %, or to at least about 70 wt %, of acrylic acid, that may be neutralized to at least about 20 mol %, or to at least about 50 mol %, or from about 60 to about 85 mol %.

It should further be noted, that the compound comprising the at least one anion as well as the polycation does not have to be immobilized in the whole surface region. However, this compound may be immobilized on at least about 5%, or at least about 10%, or at least about 20%, or at least 30% of the outer surface.

Furthermore, the polymer structures according to the invention may be characterized by at least one of the following properties:
(β1) no caking after three hours, or after six hours, or after 12 hours in the “anti-caking” test described in WO 00/10619 A1;
(β2) with a CRC value determined according to ERT 441.2-02 (CRC=Centrifugation Retention Capacity; in the case of particles, respectively determined for the total particle fraction) of less than about 26 g/g, an SFC value (SFC=Saline Flow Conductivity) determined according to the Test Method described here, of at least about 80×10⁻⁷ cm³ sg⁻¹, or at least about 90×10⁻⁷ cm³ sg⁻¹ or at least about 100×10⁻⁷ cm³ s g⁻¹;
(β3) with a CRC value determined according to ERT 441.2-02 from about 26 to less than about 27 g/g, an SFC value determined according to the test method described herein of at least about 70×10⁻⁷ cm³ sg⁻¹, or at least about 80×10⁻⁷ cm³ sg⁻¹, or at least about 90×10⁻⁷ cm³ s g⁻¹;
(β4) with a CRC value determined according to ERT 441.2-02 of from about 27 to less than about 28 g/g, an SFC value determined according to the test method described herein of at least about 60×10⁻⁷ cm³sg⁻¹, or at least about 70×10⁻⁷ cm³sg⁻¹, or at least about 80×10⁻⁷ cm³ sg⁻¹;
(β5) with a CRC value determined according to ERT 441.2-02 within the range from about 28 to less than about 29 g/g, an SFC value determined according to the test method described herein of at least about 45×10⁻⁷ cm³sg⁻¹, or at least about 55×10⁻⁷ cm³sg⁻¹, or at least about 65×10⁻⁷ cm³sg⁻¹;
(β6) with a CRC value determined according to ERT 441.2-02 of from about 29 to less than about 30 g/g, an SFC value determined according to the test method described herein of at least about 30×10⁻⁷ cm³ s g⁻¹, or at least about 40×10⁻⁷ cm³ s g⁻¹, or at least about 50×10⁻⁷ cm³ s g⁻¹;
(β7) with a CRC value determined according to ERT 441.2-02 of from about 30 to less than about 31 g/g, an SFC value determined according to the test method described herein of at least about 20×10⁻⁷ cm³ s g⁻¹, or at least about 30×10⁻⁷ cm³ s g⁻¹, or at least about 40×10⁻⁷ cm³ s g⁻¹;
(β8) with a CRC value determined according to ERT 441.2-02 of at least about 31 g/g, an SFC value determined according to the test method described herein of at least about 10×10⁻⁷ cm³sg⁻¹, at least about 20×10⁻⁷ cm³ s g⁻¹, or at least about 30×10⁻⁷ cm³sg⁻¹;
(β9) A Wicking Index after 1 minute determined according to the test method described herein of at least about 7.5 cm, or at least about 8.5 cm, or at least about 10.0 cm;
(β10) a degree of neutralization of at most about 75 mol %, or at most about 70 mol %, or at most about 65 mol %.

It is preferred that an SFC value of about 750×10⁻⁷ cm³ s g⁻¹, or of about 500×10⁻⁷ cm³ s g⁻¹, or of about 300×10⁻⁷ cm³ s g⁻¹, or of about 260×10⁻⁷ cm³ s g⁻¹, or of about 249×10⁻⁷ cm³ s g⁻¹ is not exceeded. The polymer structure according to the invention may have a Wicking Index after one minute of at most about 100 cm, or at most about 75 cm, or at most about 50 cm, or at most about 25 cm, or at most about 10.5 cm.

Further preferred embodiments of the polymer structures according to the invention comprise each conceivable combination of the above features (β1) to (β10), whereby the embodiments of the following feature combinations may be included: (β1), (β2), (β3), (β4), (β5), (β6), (β7), (β8), (β9), (β10), (β1)(β9), (β2)(β3)(β4)(β5)(β6)(β7)(β8)(β9) and (β1)(β2)(β3)(β4)(β5)(β6)(β7)(β8)(β9)(β10), whereby (β9), (β1)(β9), and (β1)(β2)(β3)(β4)(β5)(β6)(β7)(β8)(β9)(β10) are examples.

A contribution to the solution of the above-mentioned objects is also provided by a process for treatment of the surface of water-absorbing polymer structures, comprising the following steps:
i) providing an untreated water-absorbing polymer structure,
ii) bringing into contact the untreated water-absorbing polymer structure with a compound comprising at least one anion and a polycation, and
iii) optionally, post-crosslinking the water-absorbing polymer structure, whereby the process step iii) can be carried out before, during, or after the process step ii).

“Untreated” in the context of the present invention means that the water-absorbing polymer structure has not yet been brought into contact with the compound comprising at least one anion and a polycation of structure I and has also not yet been surface post-crosslinked. The description “untreated” does not, however, exclude that the water-absorbing polymer structure can be modified by means of other surface modification measures, such as, for example, coating with silicon dioxide or silica for the purpose of increasing the permeability of the polymer structures in the swollen state, or surface treatment with aluminum salts.

In process step i), preferably, polymers may be provided as untreated, water-absorbing polymer structures, which have been obtained by a process comprising the following steps:
a) radical polymerization of acid groups-carrying, ethylenically unsaturated, optionally partially neutralized monomers in the presence of a crosslinker to form a hydrogel;
b) optionally, comminution of the hydrogel;
c) at least partial drying of the optionally comminuted hydrogel to obtain water-absorbing polymer structures;
d) optionally, milling of the thus-obtained absorbent polymer structure and sieving to a desired particle size fraction; and
e) optionally, further surface modification of the thus-obtained water-absorbing polymer structures.

The radical polymerization occurring in process step a) may occur in aqueous solution, whereby this aqueous solution, in addition to water as solvent, may comprise:
(α1) the ethylenically unsaturated, acid groups-carrying monomers or salts thereof, such as acrylic acid,
(α2) optionally, monoethylenically unsaturated monomers which are co-polymerizable with (α1),
(α3) the crosslinker,
(α5) optionally, a water-soluble polymer, and
(α7) optionally, one or more additives.

As monoethylenically unsaturated monomers that are co-polymerizable with (α1), water-soluble polymers and additives, include those compounds that have already been mentioned in the context of the polymer structures according to the invention as monomers co-polymerizable with (α1), as water-soluble polymers and as additives respectively.

Water-absorbing polymer structures may be prepared from the above-mentioned monomers, co-monomers, crosslinkers, water-soluble polymers, and additives by various polymerization methods. Bulk polymerization that may be performed in kneader reactors such as extruders, solution polymerization, spray polymerization, inverse emulsion polymerization, and inverse suspension polymerization may, for example, be mentioned in this context.

Solution polymerization may be carried out in water as solvent. The solution polymerization may occur continuously or discontinuously. A broad range of possible variations with respect to reaction conditions such as temperatures, type, and amount of the initiators as well as the reaction solution can be found in the state of the art. Typical processes are described in the following patent documents: U.S. Pat. No. 4,286,082, DE 27 06 135, U.S. Pat. No. 4,076,663, DE 35 03 458, DE 40 20 780, DE 42 44 548, DE 43 23 001, DE 43 33 056, and DE 44 18 818.

The polymerization may be started by means of an initiator, as is commonly the case. As initiator for the initiation of the polymerization, all initiators which form radicals under the polymerization conditions may be used, which are commonly used in the production of superabsorbers. An initiation of the polymerization through the action of electron beams on the polymerizable, aqueous mixture may be used. The polymerization may also be started in the absence of initiators of the above-mentioned type by the action of energetic radiation in the presence of photo-initiators. Polymerization initiators may be dissolved or dispersed in a solution of monomers according to the invention. As initiators, all compounds known to the skilled person which decompose into radicals are considered. In particular, those initiators which have already been mentioned in WO 2004/037903 A2 as possible initiators fall into this group. A redox system consisting of hydrogen peroxide, sodium peroxodisulfate, and ascorbic acid may be used.

Inverse suspension and emulsion polymerization may also be applied to the production of the polymer structures. According to these processes, an aqueous, partially neutralized solution of the monomers (α1) and (α2), optionally comprising water-soluble polymers and additives, may be dispersed with the aid of protective colloids and/or emulsifying agents in a hydrophobic organic solvent, and the polymerization started by radical initiators. The crosslinkers may be either dissolved in the monomer solution and are dosed together with this solution, or are added separately and optionally during the polymerization. Optionally, the addition of a water-soluble polymer (α4) as graft basis occurs by means of the monomer solution or by direct presentation into the oil phase. The water is then removed azeotropically and the polymer filtered off.

Furthermore, both with solution polymerization and with inverse suspension, and emulsion polymerization, the crosslinking may occur by polymerization in of the poly-functional crosslinker dissolved in the monomer solution and/or by reaction of suitable crosslinkers with functional groups of the polymers during the polymerization step. The processes are described, for example, in the publications U.S. Pat. No. 4,340,706, DE 37 13 601, DE 28 40 010 and WO 96/05234 A1.

The hydrogels obtained by solution polymerization or by inverse suspension and emulsion polymerization in process step a) may be at least partially dried in process step c).

In particular in the case of solution polymerization, the hydrogels may be first comminuted before the drying in an additional process step b). This comminution may occur by means of comminuting devices known to the skilled person, such as, for example, a meat grinder (“Fleischwolf”).

The drying of the hydrogel may occur in suitable dryers or ovens. Examples of suitable dryers include rotary ovens, fluidized bed dryers, plate dryers, paddle dryers, or infrared dryers. The drying of the hydrogel in process step c) may occur to a water content of from about 0.5 to about 50 wt %, or from about 1 to about 25 wt %, or from about 2 to about 10 wt %, whereby the drying temperatures are generally from about 100 to about 200° C.

The at least partially dried water-absorbing polymer structures obtained in process step c) may, in particular if they were obtained by solution polymerization, be comminuted in a further process step d) and sieved to the above-mentioned desired particle size. The comminuting of the dried, water-absorbing polymer structures preferably occurs in a suitable mechanical comminution device, such as, for example, a ball mill.

Following the drying of the hydrogels, and the optionally carried out further confectioning of the dried water-absorbing polymer structures, these can be modified in the surface region in a further process step e) (excepted from the surface modification carried out in process step e) is the modification with the compound comprising at least one anion and a polycation which is described more closely in the following, and also the surface post-crosslinking).

Modification measures include the bringing into contact of the outer region of the polymer structure with a compound comprising Al³⁺ ions before, during, or after the bringing into contact with the post-crosslinker or with the fluid comprising the post-crosslinker respectively. The compound comprising Al³⁺ ions may be brought into contact with the polymer structures in an amount from about 0.01 to about 30 wt %, or in an amount from about 0.1 to about 20 wt %, or from about 0.3 to about 5 wt %, respectively based upon the weight of the polymer structure.

The bringing into contact of the outer region of the polymer structures with the Al³⁺ ions-comprising compound may occur by the mixing of the polymer structure with the compound under dry conditions, or by bringing the polymer structure into contact with a fluid F₁ comprising a solvent, such as water, organic solvents miscible with water such as methanol or ethanol or mixtures of at least two thereof, as well as the Al³⁺ ions-comprising compound, whereby the bringing into contact may occur by spraying the polymer particles with the fluid F₁ and combining. In this context, the bringing into contact of the polymer structure with the fluid F₁ comprising the Al³⁺ ions-comprising compound may occur in a two-step process. The two-step process may comprise a first mixing, in which a plurality of polymer structures is combined with the fluid F₁ and a second mixing, in which the fluid F₁ is homogenized within the polymer structures, whereby the polymer structures are mixed in the first mixing with a speed such that the kinetic energy of the individual polymer structures is larger on average than the adhesion energy between the individual polymer structures, and the polymer structures in the second mixing are mixed with a lower speed than in the first mixing.

By means of the treatment of the polymer structures with the fluid F₁ comprising the Al³⁺ ions-comprising compound by the above-described, two-step process, polymer structures with improved absorption properties may be obtained.

The Al³⁺ ions-comprising compound, without taking into account water of crystallization, may include in the fluid F₁ an amount from about 0.1 to about 50 wt %, or from about 1 to about 30 wt %, respectively based on the total weight of the fluid F₁. The fluid F₁ may be brought into contact with the polymer structures in an amount within a range from about 0.01 to about 15 wt %, or from about 0.05 to about 6 wt %, respectively based on the weight of the polymer structures.

Compounds comprising Al³⁺ ions include AlCl₃×6H₂O, NaAl(SO₄)₂×12H₂O, KAl(SO₄)₂×12H₂O, or Al₂(SO₄)₃×14-18H₂O.

The bringing into contact of the water-absorbing polymer structures with inorganic particles, for example with fine particulate silicon dioxide, may be applied in aqueous suspension, or with silica salt.

The above modification measures carried out in process step e), in particular the treatment with an Al³⁺ ions-comprising compound, may, in principle, also occur during process steps ii) and iii) or also after carrying out process steps ii) or iii), whereby the application of these modification measures after carrying out process steps ii) and iii) is another enablement.

In process step ii) of the process according to the invention, the untreated water absorbing polymer structures may be brought into contact with a compound comprising at least one anion and a polycation. The polycation may be a polycation of structure I:

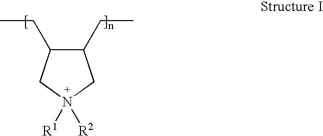

in which
R¹ and R² may be the same or different and represent a hydrocarbon residue with 1 to 10 carbon atoms, or from 1 to 7 carbon atoms, or from 1 to 4 carbon atoms, or from 1 to 2 carbon atoms, or a methyl group; and
n has a value of at least about 25, or at least about 31, or at least about 100, or at least about 1,000, or least about 2,000, or at least about 2,500, or at least about 3,000, or at least about 5,000.
   The compound comprising at least one anion and a polycation may have a molecular weight of more than about 3,000 g/mol, or more than about 4,000 g/mol, or more than about 5,000 g/mol, or more than about 7,000 g/mol, or more than about 10,000 g/mol.

The polycation may be a polydiallyldimethylammonium chloride with a value for n of at least about 25, at least about 31, or at least about 100, at least about 1,000, or at least about 2,000, or at least about 2,500, or at least about 3,000, or at least about 5,000.

Furthermore, according to the process according to the invention, in process step ii), the compound comprising the at least one anion and the polycation may be brought into contact with the untreated water-absorbing polymer structure directly or by means of a further fluid F₂ comprising a solvent, such as water, organic solvents miscible with water, such as, for example, methanol, or ethanol, or mixtures of at least two thereof, as well as this compound.

The untreated water-absorbing polymer structure may be brought into contact with this compound in an amount from 0.001 to about 10 wt %, or 0.01 to about 7.5 wt %, or from about 0.5 to about 5 wt %, based on the weight of the water-absorbing polymer structure. If this compound is used in the form of a fluid F₂, the compound in the fluid F₂ may be in the form from about 10 to about 80 wt %, or from about 20 to about 70 wt %, or from about 30 to about 60 wt % solution, such as an aqueous solution, may be brought into contact with the untreated water-absorbing polymer structure.

Suitable mixing aggregates for applying the fluid F₂ may include the Patterson-Kelley mixer, Drais turbulence mixer, Lödige mixer, Ruberg mixer, screw mixer, plate mixer, and fluidized bed mixer as well as continuously operating vertical mixers, in which the polymer structure is mixed by means of rotating knives at high frequency (Schugi mixer).

In process step iii), the surface post-crosslinking of the water-absorbing polymer structure optionally occurs, during which the polymer structures may first be brought into contact with a surface post-crosslinker and heated. Here, in particular if the post-crosslinker is not liquid under the post-crosslinking conditions, the post-crosslinker may be brought into contact with the polymer particles in the form of a fluid F₃ comprising the post-crosslinker as well as a solvent. The solvent may be water, or organic solvents which are miscible with water such as, for example, methanol, ethanol, 1-propanol, 2-propanol, 1-butanol, or mixtures of at least two of these solvents, whereby water is most preferred as solvent. The post-crosslinker may be included in the fluid F₃ in an amount from about 5 to about 75 wt %, or from about 10 to about 50 wt %, or from about 15 to about 40 wt %, based on the total weight of the fluid F₃.

The bringing into contact of the polymer structure with the fluid F₃ comprising the post-crosslinker may occur in the process according to the invention by good mixing of the fluid F₃ with the polymer structure.

Suitable mix aggregates for applying the fluid F₃ may include the Patterson-Kelley mixer, Drais turbulence mixer, Lödige mixer, Ruberg mixer, screw mixer, plate mixer, and fluidized bed mixer as well as continuously operating vertical mixers, in which the polymer structure is mixed at high frequency by means of rotating knives (Schugi mixer).

In the process according to the invention, during the post-crosslinking, the polymer structure may be brought into contact with at most about 20 wt %, or with at most about 15 wt %, or with at most about 10 wt %, or with at most about 5 wt % of solvent, such as water, or with less than about 3 wt %, respectively based upon the weight of the polymer structure.

For polymer structures in the form of ball-shaped particles, the bringing into contact occurs in such a way that only the outer region, not the inner region of the particulate polymer structures, are brought into contact with the fluid F₃ and thus with the post-crosslinker.

Post-crosslinkers that may be used in the process may include compounds that comprise at least two functional groups that may react with functional groups of a polymer structure in a condensation reaction (=condensation crosslinker), in an addition reaction, or in a ring-opening reaction, or polyvalent metal cations that enable a crosslinking of the polymer structure by means of electrostatic interactions between the polyvalent metal cation, and the functional groups of a polymer structure. Preferred post-crosslinkers, according to the invention, include those that are mentioned in WO 2004/037903 A2 as crosslinkers of crosslinker classes II and IV.

Post-crosslinkers may include condensation crosslinkers such as, for example, diethylene glycol, triethyelene glycol, polyethylene glycol, glycerine, polyglycerine, propylene glycol, diethanolamine, triethanolamine, polyoxypropylene, oxyethylene-oxypropylene block co-polymers or oxypropylene-block co-polymers, sorbitan fatty esters, polyoxyethylenesorbitan fatty acid esters, trimethylolpropane, pentaerythritol, polyvinylalcohol, sorbitol, 1,3-dioxolan-2-one (ethylene carbonate), 4-methyl-1,3-dioxolan-2-one (propylene carbonate), 4,5-dimethyl-1,3-dioxolan-2-one, 4,4-dimethyl-1,3-dioxolan-2-one, 4-ethyl-1,3-dioxolan-2-one, 4-hydroxymethyl-1,3-dioxolan-2-one, 1,3-dioxan-2-one, 4-methyl-1,3-dioxan-2-one, 4,6-dimethyl-1,3-dioxan-2-one as well as 1,3-dioxolan-2-one.

After the polymer structures have been brought into contact with the post-crosslinker or with the fluid comprising the post-crosslinker respectively, they may be heated to a temperature from about 50 to about 300° C., or from about 75 to about 275° C., or from about 150 to about 250° C., so that the outer region of the polymer structures may be more strongly crosslinked compared to the inner region (=post-crosslinking). The time duration of the heat treatment may be limited by the risk that the desired property profile of the polymer structures is destroyed as a result of the action of heating.

The bringing into contact of the untreated water-absorbing polymer structure with the compound comprising at least one anion and a polycation or with the fluid F₂ comprising this compound in process step ii) may occur at different points in time of the process according to the invention:
1. The compound comprising at least one anion and a polycation or respectively the fluid F₂ may be brought into contact with the polymer gel obtained in process step b), which polymer gel preferably still has a water content of at least about 10 wt %, or at least about 20 wt %, or at least about 30 wt %, and a surface post-crosslinking according to process step iii) only occurs afterwards.
2. The compound comprising at least one anion and a polycation or respectively the fluid F₂ may be brought into contact with the polymer gel that has been comminuted in process step b), whereby this polymer gel has a water content of at least about 10 wt %, or at least about 20 wt %, or at least about 30 wt %. The surface post-crosslinking according to process step iii) may occur before, during, or after the bringing into contact with the compound.
3. The compound comprising at least one anion and a polycation, or respectively the fluid F₂ may be brought into contact with the dried water-absorbing polymer structure obtained in process step c). The surface post-crosslinking according to process step iii) may occur before, during, or after the bringing into contact with the compound.
4. The compound comprising at least one anion and a polycation or respectively the fluid F₂ may be brought into contact with the comminuted water-absorbing polymer structure obtained in process step d). The surface post-crosslinking according to process step iii) may occur before, during, or after the bringing into contact with the compound.
5. The compound comprising at least one anion and a polycation or respectively the fluid F₂ may be brought into contact with the surface-modified water-absorbing polymer structure obtained in process step i). The surface-post-crosslinking according to process step iii) may occur before, during, or after the bringing into contact with the compound.

In an embodiment of the invention, process steps ii) and iii) may be carried out at the same time. In this case, the compound comprising at least one anion and a polycation or respectively the fluid F₂ is used in combination with F₃, whereby a common fluid comprising the compound comprising at least one anion and a polycation as well as a post-crosslinker can be used. After the polymer structure has been brought into contact with the post-crosslinker and with the compound comprising at least one anion and a polycation at the same time in process steps ii) and iii), the post-crosslinking may occur by heating the polymer structure to the above-mentioned post-crosslinking temperatures.

Each of these variants 1 to 5 represents a particular embodiment of the process according to the invention. In variant 4, following the surface post-crosslinking, a further modification may occur by means of an Al³⁺ ions-comprising compound according to the above-described process step e).

The water-absorbing, surface post-crosslinked polymer obtained by the above described process variants and brought into contact with the at least one anion and the polycation, may be brought into contact with a fine particulate component in a further process step iv) and then to immobilize the fine particulates on the surface of the water-absorbing polymer structures. This particular embodiment may be used if the water-absorbing polymer structure has not been brought into contact with Al³⁺ ions or inorganic particles before or during process step ii) and/or iii).

The fine particulates may be an organic or inorganic fine particulate, whereby an inorganic fine particulate may be used.

Furthermore, according to a particular embodiment of the process according to the invention, the fine particulates may be water-soluble fine particulates, whereby water-soluble fine particulates, preferably fine particulates, are understood, of which at 25° C. at least 1 g, or at least 5 g, or at least about 10 g may be dissolved in 100 ml water.

According to another embodiment of the process according to the invention, the fine particulates may be water-insoluble fine particulates, whereby at 25° C., less than 1 g, or less than 0.1 g, or less than about 0.0 μg may be dissolved in 100 ml water.

Inorganic fine particulate may comprise an at least divalent, or at least trivalent metal. The at least divalent metals may be selected from beryllium, magnesium, calcium, barium, strontium, aluminum, boron, zirconium, silicon, scandium, vanadium, cerium, yttrium, lanthanum, niobium, chromium, molybdenum, manganese, palladium, platinum, cadmium, mercury, iron, copper, zinc, titanium, cobalt, or nickel.

The preferably inorganic fine particulate may be present in the form of a salt comprising the at least divalent metal in the form of an at least divalent cation Kⁿ⁺ (with n≧2) and at least one anion A^{m-} (with m≧1). Fine particulates may be selected from aluminum salts, such as, for example, aluminum chloride, polyaluminum chloride, aluminum sulfate, aluminum nitrate, bis-aluminum potassium sulfate, bis-aluminum sodium sulfate, aluminum lactate, aluminum oxalate, aluminum citrate, aluminum glyoxylate, aluminum succinate, aluminum itaconate, aluminum crotonate, aluminum butyrate, aluminum sorbate, aluminum malonate, aluminum benzoate, aluminum tartrate, aluminum pyruvate, aluminum valerate, aluminum formate, aluminum glutarate, aluminum propanate or aluminum acetate, phosphates of the formula M₄P₂O₇, M₂HPO₄ or M₃PO₄, wherein M stands for one equivalent of a metal selected from calcium, magnesium, strontium, barium, zinc, iron, aluminum, titanium, zirconium, hafnium, tin, cerium, scandium, yttrium or lanthanum or mixtures thereof, such as, for example, calcium hydrogenphosphate, tertiary calcium phosphate, apatite, Thomas meal with the formula Ca₅(PO₄)[SiO₄], berlinite with the formula AlPO₄ or Rhenania phosphate with the formula 3 CaNaPO₄Ca₂SiO₄, calcium chloride, calcium nitrate, magnesium chloride, magnesium sulfate, magnesium nitrate, zinc chloride, zinc sulfate, zinc nitrate, copper sulfate, cobalt chloride, zirconium chloride, zirconium sulfate, zirconium nitrate, silicon dioxides such as, for example, Aerosil®, or titanium dioxides. Another preferred compound which is considered as a salt is Al(O)OH.

Examples of fine particulates include aluminum salts selected from the group comprising AlCl₃×6H₂O, NaAl(SO₄)₂×12H₂O, KAl(SO₄)₂×12H₂O, Al₂(SO₄)₃×14-18H₂O, aluminum lactate, or aluminum citrate.

The fine particulate component may comprise at least two different sorts of fine particulates, for example an aluminum salt and a salt which is different to an aluminum salt, or two different aluminum salts.

At least about 50 wt %, or at least about 75 wt %, or at least about 95 wt %, or at least about 99 wt % of the fine particulates have an average particle diameter (weight average), from about 10 to about 1000 μm, or from about 50 to about 800 μm, or from about 100 to about 600 μm, or from about 200 to about 400 μm respectively determined by means of processes known to the skilled person for determination of particle size, for example by sieve analysis or by means of a Coulter counter.

The amount of fine particulates with an average particle size of about 150 μm or more is more than about 20 wt %, or more than about 30 wt %, or more than about 40 wt %, respectively based on the total weight of the fine particulates.

The fine particulate component may additionally comprise a binder. Organic compounds may be used as binder. The organic compound may be a linear polymer selected from polyurethanes, polyesters, polyamides, polyester amides, polyolefins, polyvinyl esters, polyethers, polystyrenes, polyimides, in particular polyether imides, polyimines, sulfur polymers, in particular polysulfone, polyacetals, in particular polyoxymethylene, fluorine polymers, in particular polyvinylidene fluoride, styrene-olefin copolymers, polyacrylates, ethylene-vinylacetate copolymers, or mixtures of two or more of the polymers mentioned.

Suitable linear polyethers may comprise polyalkylene glycols, in particular polyethylene glycols, polypropylene glycols, poly(ethylene/propylene) glycols with statistical or block-like arrangement of the ethylene or propylene monomers or mixtures of at least two of these polyalkylene glycols.

Other suitable linear polymers include those polymers which were mentioned in DE-A-103 34 286 as “thermoplastic adhesives” (“thermoplastische Klebstoffe”).

The organic compound as binder principal component may have a weight average of the molecular weight M_{w} from about 100 to about 1,000,000 g/mol, or from about 1000 to about 100,000 g/mol, or from about 5000 to about 20,000 g/mol.

The binder may be present in particulate form, whereby in this context in particular particulate polyalkylene glycols, such as, for example, particulate polyethylene glycols or polypropylene glycols may be advantageous as particulate binder, wherein the particulate binder is based to at least about 50 wt %, or at least about 75 wt %, or at least about 95 wt %, or least 99 wt % upon particles with an average particle diameter (weight average) of less than about 500 μm, or less than about 400 μm, or less than about 300 μm, or less than about 150 μm, respectively determined by processes known to the skilled person for determination of particle size, for example by sieve analysis or by means of a Coulter counter.

The amount of fine particulates, which may be brought into contact with the water-absorbing polymer structure in process step iv), may lie from 0.001 to about 10 wt %, or from 0.01 to about 5 wt %, or from 0.1 to about 2 wt %, respectively based upon the weight of the water-absorbing polymer structure, while the weight of the binding agent, if used, may lie from 0.0001 to about 5 wt %, or from 0.001 to about 2 wt %, respectively based on the weight of the water-absorbing polymer structure. The weight ratio between fine particulates and binder may lie within a range of fine particulates:binder from about 20:1 to about 1:20, or from 10:1 to 1:10, or from 10:1 to 2:1.

The bringing into contact of the fine particulate with the water-absorbing polymer structure may occur by combination of the fine particulate component with the water-absorbing polymer structure in mixing devices known to the skilled person. After or during the mixing of the fine particulate component with the water-absorbing polymer structure, at least a part of the fine particulate may then be immobilized on the surface of the water-absorbing polymer structure, whereby the immobilization may occur by heating. The immobilization may occur by heating to a temperature which occurs at most about 10%, or at most about 7.5%, or at most about 5% above the softening temperature of a component of the fine particulate component, or above the softening temperature of the binder. The heating occurs to a temperature from about 30 to about 200° C., or from about 50 to about 160° C., or from about 100 to about 140° C.

In principle, at least four ways of proceeding are conceivable:
According to variant VA, first, the mixture of fine particulate components and water-absorbing polymer structure may be prepared, and this is then heated to the above-mentioned temperatures for the purpose of immobilization of the fine particulate.
According to variant VB, first, before the combining with the fine particulate, the water-absorbing polymer structures may be heated to the above-described temperature, and then this pre-warmed water-absorbing polymer structure is combined with the not pre-warmed fine particulate component.
According to variant V_{C}, first, before the combining with the fine particulate, the water-absorbing polymer structure and the fine particulate component may each be heated separately to the above-described temperature, and then the pre-warmed water-absorbing polymer structure may be combined with the likewise pre-warmed fine particulate component. According to a particular embodiment of this variant V_{C}, cool the fine particulate component after the heating and before the combining with the pre-warmed water-absorbing polymer structures to a temperature within a range from about 10 to about 100° C., or from about 15 to about 75° C., or from about 20 to about 60° C., afterwards optionally to comminute, for example using a pestle and mortar, and then to combine the cooled and optionally comminuted fine particulate component with the pre-warmed water-absorbing polymer structures.
According to variant V_{D}, first, before the combining with the fine particulate, the fine particulate component may be heated to the above-described temperature and then this pre-warmed water-absorbing polymer structure may be combined with the not pre-warmed water-absorbing polymer structures. According to a particular embodiment of this variant V_{D}, one may first cool the fine particulate component after the heating and before the combining with the pre-warmed water-absorbing polymer structures to a temperature from about 10 to about 100° C., or from about 15 to about 75° C., or from about 20 to about 60° C., afterwards optionally to comminute, for example using a pestle and mortar, and then to combine the cooled and optionally comminuted fine particulate component with the not pre-warmed water-absorbing polymer structures.

The formulation “not pre-warmed” means that the temperature of the respective component is lower than about 100° C., or lower than about 80° C., or lower than about 40° C.

The duration of the heating may be from about 10 seconds to about 60 minutes, or from about 30 seconds to about 30 minutes, depending on the mixing speed and the mixing device used.

A further process step may include v), in which the water-absorbing polymer structures, upon whose surfaces the fine particulates are immobilized, may be mixed for a further period from about 10 minutes to about 5 hours, or from about 30 minutes to about 3 hours, follows process step iv), in order to enable as homogeneous a distribution as possible of the fine particulates, whereby for this purpose mixing devices known to the skilled person may be used. In this further process step, the superabsorber composition having the temperature which it has after the immobilization in process step iv) may be introduced into the mixer, whereby the water-absorbing polymer structures, upon whose surfaces the fine particulates are immobilized, may then be cooled in the course of the mixing, in one embodiment, constantly to a lower temperature, or to room temperature.

A further contribution to the solution of the above-described objects may be provided by the surface-treated, water-absorbing polymer structures obtainable by the process according to the invention.

The above-described water-absorbing polymer structures may have the same properties as the surface-treated water-absorbing polymer structures obtainable by the process according to the invention. It is noted that each value which has been given in the context of the process according to the invention and the polymer structures according to the invention as lower limits of features according to the invention without upper limits, have upper limits of 20 times, or 10 times, or 5 times the value of the lower limit.

A further contribution to solving the above-described objects is provided by a composite comprising the surface-treated water-absorbing polymer structures according to the invention, or respectively the surface-treated water-absorbing polymer structures obtainable by a process according to the invention and a substrate. The polymer structures according to the invention and the substrate may be firmly joined together with each other. Substrates may be sheets made from polymers, such as, for example, polyethylene, polypropylene or polyamide, metals, non-wovens, fluff, tissues, woven materials, natural or synthetic fibers, or other foams. According to an embodiment of the invention, the composite comprises at least one region, which comprises the water-absorbing polymer structure according to the invention in an amount from about 15 to 100 wt %, or from about 30 to 100 wt %, or from about 50 to 99.99 wt %, or from about 60 to 99.99 wt %, or from about 70 to about 99 wt %, respectively based on the total weight of the relevant region of the composite, whereby this region may have a size of at least 0.01 cm³, or at least 0.1 cm³, or at least about 0.5 cm³.

In another embodiment of the composite according to the invention, is a sheet-like composite, as described in WO-A-02/056812 as “absorbent material”. The disclosure of WO-A-02/056812, limited to the exact construction of the composite, the mass per unit area of its components and of its thickness is hereby introduced as reference and represents a part of the disclosure of the present invention.

A further contribution to the solution of the above-mentioned objects is provided by a process for production of a composite, whereby the water-absorbing polymer structures according to the invention or respectively the surface-treated water-absorbing polymer structures obtainable by the process according to the invention and a substrate and optionally an additive may be brought into contact with each other.

According to a particular embodiment of the process according to the invention for production of a composite, this process comprises the following process steps:
I) provision of a substrate;
II) provision of an at least surface crosslinked water-absorbing polymer structure, whose surface has been brought into contact with a compound comprising a polycation and at least one anion;
III) provision of a plurality of fine particulate component comprising fine particles;
IV) bringing into contact of the substrate with the at least surface crosslinked water-absorbing polymer structure;
V) bringing into contact of the at least surface crosslinked water-absorbing polymer structure with the fine particulate component; and
VI) immobilization of at least a part of the fine particles on the surface of the polymer surface.

A compound comprising a polycation and at least one anion may be used as a fine particulate component as well as compounds which have already been described above as fine particulate components respectively in connection with the water-absorbing polymer structures according to the invention or respectively in connection with the process according to the invention for treatment of the surface of water-absorbing polymer structures.

According to a variant of this particular embodiment of the inventive process for production of a composite, first the substrate and the surface post-crosslinked polymer structure which has been brought into contact with a compound comprising a polycation and at least one anion are brought into contact, by first providing the substrate and then applying, by sprinkling, the surface post-crosslinked polymer structure either uniformly or on defined areas of the substrate surface. The water-absorbing polymer structures situated on the substrate surface may then brought into contact with the fine particulate component, for example by sprinkling the fine particulate component on the surface post-crosslinked polymer structure situated on the substrate surface. The immobilization of the fine particulate components on the surface of the polymer structure then may occur, whereby this immobilization may occur by the heating described above in connection with the inventive process for treatment of the surface of water-absorbing polymer structures. In this variant of the particular embodiment of the inventive process for production of a composite, process step V) therefore occurs after process step IV).

According to another variant of this particular embodiment of the inventive process for production of a composite, first the substrate is provided. Then the surface post-crosslinked polymer structure is brought into contact with the substrate, by first providing the substrate and then applying, by sprinkling, the surface post-crosslinked polymer structure either uniformly or on defined areas of the substrate surface. Before the polymer structure is brought into contact with the substrate surface, the water-absorbing polymer structures may be brought into contact with the fine particulate component, for example by combining the fine particulate component with the surface post-crosslinked polymer structure before it is sprinkled onto the substrate surface. After the polymer structures have been brought into contact with the substrate, the immobilization of the fine particulate component on the surface of the polymer structure may occur. In this variant of the particular embodiment of the inventive process for production of a composite, process step V) therefore occurs before process step IV).

A contribution to the solution of the above-mentioned objects is also provided by a composite obtainable by the above-described process, whereby this composite may have the same properties as the above described composite according to the invention.

A further contribution to the solution of the above-mentioned objects may be provided by chemical products comprising the water-absorbing polymer structures according to the invention or a composite according to the invention. Preferred chemical products are selected from foams, formed bodies, fibers, sheets, films, cables, sealing materials, liquid-absorbing hygiene articles, in particular diapers and sanitary napkins, carriers for plant- or fungus-growth-regulating agents or plant protection active substances, additives for construction materials, packaging materials, or soil additives.

The use of the water-absorbing polymer structures according to the invention or of the composite according to the invention in chemical products, such as in the above-mentioned chemical products, or in hygiene articles such as diapers or sanitary napkins, as well as the use of the superabsorber particles as carrier for plant- or fungus-growth-regulating agents or plant protection active substances also provide a contribution to the solution of the above-mentioned objects. In the use as carrier for plant- or fungus-growth-regulating agents or plant protection active substances, it is preferred that the plant- or fungus-growth-regulating agent or plant protection active substances can be released over a time period controlled by the carrier.

A further contribution to the solution of the above-mentioned object may be provided by the use of a compound comprising at least one anion and a polycation of structure I:

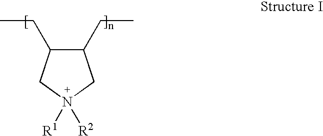

in which
R₁ and R₂ can be the same or different and represent a hydrocarbon residue with 1 to 10 carbon atoms, or 1 to 7 carbon atoms, or 1 to 4 carbon atoms, or 1 to 2 carbon atoms, or a methyl group and
n has a value of at least about 25, or at least about 31, or at least about 100, or at least about 1,000, or at least about 2,000, or at least about 2,500, or at least about 3,000, or at least about 5,000,
   for treatment of the surface of water-absorbing polymer structures, and/or
   for improving the permeability of composites comprising these polymer structures and a substrate, whereby the polymer structures are comprised in the composite in an amount of at least about 50 wt %, or at least about preferably 70 wt %, or at least about 90 wt %, based on the total weight of polymer structure and substrate.

The invention is now more closely illustrated by means of test methods and non-limiting examples.

### Test Methods

### Determination of the Permeability (SFC Test, According to WO-A-95/22356)

0.9 g of superabsorber material are weighed into a cylinder with a sieve floor and carefully distributed on the sieve surface. The superabsorber material was allowed to swell for one hour in JAYCO synthetic urine (composition: 2.0 g potassium chloride; 2.0 g sodium sulfate; 0.85 g ammonium dihydrogenphosphate; 0.15 g ammonium hydrogenphosphate; 0.19 g calcium chloride; and 0.23 g magnesium chloride as anhydrous salts dissolved in 1 L distilled water) against a pressure of 20 g/cm². After measuring the swell height of the superabsorber, 0.118 M NaCl solution from a graduated reservoir is allowed to flow through the swollen gel sheet at constant hydrostatic pressure. The swollen gel sheet is covered with a special sieve cylinder during the measurement, which ensures a uniform distribution of the 0.118 M NaCl solution above the gel and constant conditions (measurement temperature 20-25° C.) during the measurement in respect of the gel bed property. The pressure acting on the swollen superabsorber is still 20 g/cm². Using a computer and a balance, the amount of liquid which passes through the gel sheet as a function of time is determined in intervals of 20 seconds over a time period of 10 minutes. The flow rate in g/s through the swollen gel sheet is determined by means of regression analysis with extrapolation of the gradient and determination of the central point at the time point t=0 of the flow amount within the minutes 2-10. The SFC value (K) is calculated as follows:

$$K = \frac{{F}_{s} ( t = 0 ) \cdot {L}_{0}}{r \cdot A \cdot Δ {P}_{1}} = \frac{{F}_{s} ( t = 0 ) \cdot {L}_{o}}{139506}$$

whereby:
F_{S}(t=0) is the flow rate in g/s,
L₀ is the thickness of the gel sheet in cm,
R is the density of the NaCl solution (1.003 g/cm³),
A is the surface of the upper side of the gel layer in the measuring cylinder (28.27 cm²),
ΔP is the hydrostatic pressure which acts upon the gel sheet (4920 dyne/cm²), and
K is the SFC value [cm³ s g⁻¹].

### Determination of the Wicking Index

The determination of the Wicking Index occurred according to the test method described on page 6, line 36 to page 7, line 26 of EP-A-0 532 002, whereby the particles were previously sieved to a particle size within a range from 150 to 850 μm.

### EXAMPLES

### 1. Preparation of SAP Particles (Degree of Neutralization 50 Mol %)

A monomer solution consisting of 300 g acrylic acid, 166.52 g 50% sodium hydroxide solution, 497.12 g deionized water, 1.176 g monoallylpolyethyleneglycol-450-monoacrylic acid ester, 0.988 g polyethyleneglycol-300-diacrylate and 6.13 g polyethylene glycol-750-monomethacrylic acid ester methyl ether was flushed with nitrogen to remove dissolved oxygen and cooled to the start temperature of 4° C. After reaching the start temperature, the initiator solution (0.3 g sodium peroxydisulfate in 9.7 g H₂O, 0.07 g 35.5% hydrogen peroxide solution in 1.93 g H₂O and 0.015 g ascorbic acid in 4.99 g H₂O) was added. After the end temperature of about 100° C. was reached, the resulting gel was comminuted and dried at 150° C. for 120 minutes. The dried polymer was coarsely ground, milled, and sieved to a powder with a particle size from 150 to 850 μm (=powder A).

### 2. Preparation of SAP Particles (Degree of Neutralisation 70 Mol %)

A monomer solution consisting of 300 g acrylic acid, 233.12 g 50% sodium hydroxide solution, 429.42 g deionized water, 1.961 g monoallylpolyethylene glycol-450-monoacrylic acid ester, 2.372 g polyethylene glycol-300-diacrylate, and 6.13 g polyethylene glycol-750-monomethacrylic acid ester methyl ether was flushed with nitrogen to remove dissolved oxygen and cooled to the start temperature of 4° C. After reaching the start temperature, the initiator solution (0.3 g sodium peroxydisulfate in 9.7 g H₂O, 0.07 g 35.5% hydrogen peroxide solution in 1.93 g H₂O and 0.015 g ascorbic acid in 4.99 g H₂O) added. After the end temperature of about 100° C. was reached, the resulting gel was comminuted and dried at 150° C. for 120 minutes. The dried polymer was coarsely ground, milled, and sieved to a powder with a particle size from 150 to 850 μm (=powder B).

### Examples 1 and 2

### SAP-Polymer with 70 Mol % Degree of Neutralization

The powder B was combined with a solution comprising the amounts of water, ethylene carbonate as post-crosslinker and polydiallyldimethylammonium chloride (MW=450,000 g/mol) in the amounts given in the following table with vigorous stirring and then heated for the amount of time given in table 1 at the temperatures likewise given in table 1 (the amounts given of water, ethylene carbonate and polydiallyldimethylammonium chloride are respectively the amounts in grams, based on 100 grams of powder B).

TABLE 1

| | | | Polydiallyldimethylammonium | | |
|---|---|---|---|---|---|
| | | | chloride | | |
| | | Ethylene | (as 30% solution in | Time | Temperature |
| Example | Water | carbonate | H₂O) | [minutes] | [° C.] |
| 1 (not | 2.5 | 1 | 0 | 75 | 190 |
| inventive) | | | | | |
| 2 | 0 | 1 | 3 | 75 | 190 |
| (inventive) | | | | | |

The absorption properties of the polymer obtained in Examples 1 and 2 are given in the following table 2:

TABLE 2

| Polymer from | Wicking Index | SFC value [cm³ | |
|---|---|---|---|
| example | [cm] | sg⁻¹] | Retention [g/g] |
| 1 | 5.5 | 127 | 22.5 |
| 2 | 7.5 | 199 | 22.7 |

### Examples 3 and 4

### SAP Polymer with 50 Mol % Degree of Neutralization

The powder A was combined with a solution comprising the amounts given in the following table 3 of water, ethylene carbonate as post-crosslinker, and polydiallyldimethylammonium chloride (MW=450,000 g/mol) with vigorous stirring and then heated for the amount of time given in table 3 at the temperatures likewise given in table 3 (the amounts given of water, ethylene carbonate, and polydiallyldimethylammonium chloride are respectively the amounts in grams, based on 100 g of powder A):

TABLE 3

| | | | Polydiallyldimethylammonium | | |
|---|---|---|---|---|---|
| | | | chloride | | |
| | | Ethylene | (as 30% solution in | Time | Temperature |
| Example | Water | carbonate | H₂O) | [minutes] | [° C.] |
| 3 (not | 2.5 | 1 | 0 | 30 | 180 |
| inventive) | | | | | |
| 4 | 0 | 1 | 3 | 30 | 180 |
| (inventive) | | | | | |

The absorbent properties of the polymers obtained in examples 3 and 4 are detailed in the following table 4:

TABLE 4

| Polymer from | Wicking | SFC value | | Retention |
|---|---|---|---|---|
| example | Index [cm] | [cm³ sg⁻¹] | AAP [g/g] | [g/g] |
| 3 | 7.0 | 151 | 19.5 | 21.9 |
| 4 | 10.5 | 249 | 20.3 | 20.9 |

### Example 5

100 g of the polymer obtained in example 4 were pre-heated to 130° C.

A mixture of 10 g Al₂(SO)₄)₃×14H₂O, which had been milled in a centrifugal mill and sieved to a particle size within a range from 300 to 400 μm, and 1.5 g polyethylene glycol 10,000 (polyethylene glycol with a molecular weight of 10,000 g/mol), which had likewise been milled in a centrifugal mill and sieved to a particle size of less than 300 μm, was prepared. 1.15 g of the mixture of Al₂(SO)₄)₃×14H₂O and polyethylene glycol 10,000 were combined in a Krups mixer by stirring with the pre-heated water-absorbing polymer structure.

1. A water-absorbing polymer structure, whose surface has been brought into contact with a compound comprising a polycation and at least one anion and which has an absorption under a pressure of 50 g/cm² of at least about 16 g/g.

2. A water-absorbing polymer structure, whose surface has been brought into contact with a compound comprising a polycation and at least one anion, wherein the compound comprising a polycation and at least one anion has a weight average molecular weight of more than about 3,000 g/mol.

3. The water-absorbing polymer structure according to claim 1, comprising an inner region and an outer region surrounding the inner region, wherein the outer region has a higher degree of crosslinking than the inner region.

4. The water-absorbing structure according to claim 1 wherein the polycation has the structure I 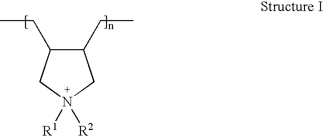
in which R¹ and R² can be the same or different and represent a hydrocarbon residue with 1 to 10 carbon atoms and n has a value of at least 25.

5. A polymer structure according to claim 4 wherein R¹ and R¹ represent a methyl group.

6. The polymer structure according to claim 4 wherein n has a value of at least about 1,000.

7. The polymer structure according to claim 4 wherein n has a value of at least about 2,000.

8. The polymer structure according to claim 4 wherein n has a value of at least about 3,000.

9. The polymer structure according to claim 4 wherein the anion is a chloride ion.

10. The polymer structure according to claim 4 wherein the polymer structure has at least one of the following properties:
(β1) no caking after three hours;
(β2) with a CRC value of less than about 26 g/g, an SFC value of at least about 80×10⁻⁷ cm³ s g⁻¹;
(β3) with a CRC value within the range from about 26 to less than 27 g/g, an SFC value of at least about 70×10⁻⁷ cm³ s g⁻¹;
(β4) with a CRC value within the range from about 27 to less than 28 g/g, an SFC value of at least about 60×10⁻⁷ cm³ s g⁻¹;
(β5) with a CRC value within the range from about 28 to less than 29 g/g, an SFC value of at least about 45×10⁻⁷ cm³ s g⁻¹;
(β6) with a CRC value within the range from about 29 to less than 30 g/g, an SFC value of at least about 30×10⁻⁷ cm³ s g⁻¹;
(β7) with a CRC value within the range from about 30 to less than 31 g/g, an SFC value of at least about 20×10⁻⁷ cm³ s g⁻¹;
(β8) with a CRC value of at least about 31 g/g, an SFC value of at least about 10×10⁻⁷ cm³ s g⁻¹;
(β9) a Wicking Index after one minute of at least about 7.5 cm;
(β10) a degree of neutralization of at most about 75 mol %.

11. A process for treatment of the surface of water-absorbing polymer structures, comprising the following steps:
i) providing an untreated water-absorbing polymer structure,
ii) bringing into contact the untreated water-absorbing polymer structure with a compound comprising at least one anion and a polycation, and
iii) post-crosslinking the water-absorbing polymer structure,
wherein the process step iii) can be carried out before, during or after process step ii).

12. The process according to claim 11, wherein the polycation has the structure I 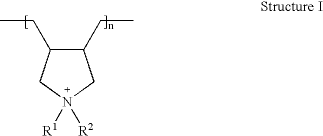
in which R¹ and R² can be the same or different and represents a hydrocarbon residue with 1 to 10 carbon atoms and
n has a value of at least 25.

13. The process according to claim 11 wherein the water-absorbing polymer structure is brought into contact with the compound in an amount within a range from about 0.001 to about 10 wt. %, based on the weight of the water-absorbing polymer structure.

14. The process according to claim 11 wherein the compound is brought into contact with the water-absorbing polymer structure in the form of an about 10 to about 80 wt. % aqueous solution.

15. The process according to claim 11 wherein the water-absorbing polymer structure has a degree of neutralization of not more than about 70 mol %.

16. (canceled)

17. A composite comprising a water-absorbing polymer structure according to claim 1 and a substrate.

18-22. (canceled)

23. The water-absorbing polymer structure according to claim 2 comprising an inner region and an outer region surrounding the inner region, wherein the outer region has a higher degree of crosslinking than the inner region.

24. The water-absorbing structure according to claim 2 wherein the polycation has the structure I 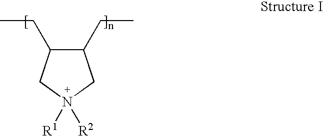
in which R¹ and R² can be the same or different and represent a hydrocarbon residue with 1 to 10 carbon atoms and n has a value of at least 25.

25. The polymer structure according to claim 5 wherein n has a value of at least about 1,000.

26. The polymer structure according to claim 5 wherein n has a value of at least about 2,000.

27. The polymer structure according to claim 5 wherein n has a value of at least about 3,000.

28. The polymer structure according to claim 5 wherein the anion is a chloride ion.

29. The polymer structure according to claim 5 wherein the polymer structure has at least one of the following properties:
(β1) no caking after three hours;
(β2) with a CRC value of less than about 26 g/g, an SFC value of at least about 80×10⁻⁷ cm³ s g⁻¹;
(β3) with a CRC value within the range from about 26 to less than 27 g/g, an SFC value of at least about 70×10⁻⁷ cm³ s g⁻¹;
(β4) with a CRC value within the range from about 27 to less than 28 g/g, an SFC value of at least about 60×10⁻⁷ cm³ s g⁻¹;
(β5) with a CRC value within the range from about 28 to less than 29 g/g, an SFC value of at least about 45×10⁻⁷ cm³ s g⁻¹;
(β6) with a CRC value within the range from about 29 to less than 30 g/g, an SFC value of at least about 30×10⁻⁷ cm³ s g⁻¹;
(β7) with a CRC value within the range from about 30 to less than 31 g/g, an SFC value of at least about 20×10⁻⁷ cm³ s g⁻¹;
(β8) with a CRC value of at least about 31 g/g, an SFC value of at least about 10×10⁻⁷ cm³ s g⁻¹;
(β9) a Wicking Index after one minute of at least about 7.5 cm;
(β10) a degree of neutralization of at most about 75 mol %.

30. The process according to claim 12 wherein the water-absorbing polymer structure is brought into contact with the compound in an amount within a range from about 0.001 to about 10 wt. %, based on the weight of the water-absorbing polymer structure.

31. The process according to claim 12 wherein the compound is brought into contact with the water-absorbing polymer structure in the form of a 10 to 80 wt. % aqueous solution.
